(19) United States
(12) Patent Application Publication
(10) Pub. No.: US 2015/0015501 A1
(43) Pub. Date: Jan. 15, 2015

(54) INFORMATION DISPLAY APPARATUS

(71) Applicant: SHARP KABUSHIKI KAISHA, Osaka (JP)

(72) Inventor: Etsuzo Adachi, Osaka-shi (JP)

(73) Assignee: SHARP KABUSHIKI KAISHA, Osaka (JP)

(21) Appl. No.: 14/242,415

(22) Filed: Apr. 1, 2014

(30) Foreign Application Priority Data
Jul. 11, 2013 (JP) 2013-145485

(51) Int. Cl. G06F 3/041

(52) U.S. Cl. CPC G06F 3/0416
USPC 345/173

(57) ABSTRACT

Provided is an information display apparatus capable of smoothly performing a presentation or the like using a touch panel. The information display apparatus is able to edit display content based on a touch to the touch panel. A touch judging portion for judging whether or not the touch panel is touched, and an image edit portion for displaying a trace of the touch to the touch panel that is judged by the touch judging portion on the touch panel as an input image are included. The image edit portion deletes the input image from the touch panel automatically after a predetermined time has elapsed.

### CROSS-NOTING PARAGRAPH

This non-provisional application claims priority under 35 U.S.C. §119(a) on Patent Application No. 2013-145485 filed in JAPAN on Jul. 11, 2013, the entire contents of which are hereby incorporated herein by reference.

### FIELD OF THE INVENTION

The present invention relates to an information display apparatus, and specifically to an information display apparatus capable of editing display content based on a touch to a touch panel.

### BACKGROUND OF THE INVENTION

This type of information display apparatus is widely used for presentations, meetings, classes, lectures and the like, and has a large touch panel having a touch sensor provided on a display. A material image from an external device or the like is left to be displayed on the display, and when the touch panel is touched with a finger of a user, a stylus or the like, it is possible to write handwritten characters and diagrams such as symbols at the touched position.

For example, Japanese Laid-Open Patent Publication No. 2004-94679 proposes a technology that enables to set an edit mode that handwritten characters and diagrams such as symbols are able to be written in the case of using a touch panel. Thereby, a trace of touch to the touch panel is highlighted as a part to which a presenter desires to draw an attention, thus making possible to make participants pay attention.

In the meantime, the above-described highlight is performed temporarily according to progress of a presentation or the like and does not need to be kept permanently.

In the technology described in Japanese Laid-Open Patent Publication No. 2004-94679, however, since highlight is continued to be displayed without being deleted from the touch panel, content before performing the highlight becomes difficult to be seen, thus posing a problem of disturbing a presentation or the like. Moreover, an operation for deleting the highlight from the touch panel is required additionally, and concentration of the presenter is lost, which also disturbs the presentation or the like.

### SUMMARY OF THE INVENTION

The present invention aims to provide an information display apparatus capable of smoothly performing a presentation or the like using a touch panel.

An object of the present invention is to provide an information display apparatus capable of editing display content based on a touch to a touch panel, comprising a touch judging portion for judging whether or not the touch panel is touched, and an image edit portion for displaying a trace of the touch to the touch panel that is judged by the touch judging portion on the touch panel as an input image, wherein the image edit portion deletes the input image from the touch panel automatically after a predetermined time has elapsed.

Another object of the present invention is to provide the information display apparatus, wherein the image edit portion synthesizes the trace of the touch to the touch panel with respect to the display content of the touch panel to display on the touch panel as the input image.

Another object of the present invention is to provide the information display apparatus, wherein a storage portion for storing, when a touch operation to the touch panel is performed a plurality of times, input time information for each touch operation is further included, and the image edit portion deletes the input image corresponding to the touch operation from the touch panel based on the input time information that is stored.

Another object of the present invention is to provide the information display apparatus, wherein a storage portion for dividing input time information of a touch operation to the touch panel into a plurality of sections for storage is further included, and the image edit portion deletes the input image corresponding to the touch operation from the touch panel based on the input time information that has been divided and stored.

Another object of the present invention is to provide the information display apparatus, wherein when a predetermined operation is performed, the image edit portion displays the input image that has been deleted from the touch panel on the touch panel again.

Another object of the present invention is to provide the information display apparatus, wherein before deleting from the touch panel automatically, the image edit portion changes a color of the input image to a color lighter than a color used for the display content of the touch panel to display on the touch panel.

Another object of the present invention is to provide the information display apparatus, wherein a storage portion for dividing input time information of a touch operation to the touch panel into a plurality of sections for storage is further included, and before deleting from the touch panel automatically, the image edit portion changes a color of the input image corresponding to the touch operation to a color lighter than a color used for the input image of last time to display on the touch panel based on the input time information that has been divided and stored.

### BRIEF DESCRIPTION OF THE DRAWINGS

FIG. 1 is a front view of an information display apparatus according to the present invention;

FIG. 2 is a block diagram showing a structure of the information display apparatus according to the present invention;

FIG. 3 is a flowchart explaining an operation in the case of switching modes according to the present invention;

FIG. 4 is a flowchart explaining an operation of a highlight mode of FIG. 3;

FIG. 5A through FIG. 5C are views explaining display by the highlight mode of FIG. 3;

FIG. 6 is a view explaining touch operation record by the highlight mode of FIG. 3;

FIG. 7A and FIG. 7B are views explaining deleting of an input image by the highlight mode of FIG. 3;

FIG. 8 is a view explaining deleting of an input image by the highlight mode of FIG. 3; and

FIG. 9 is a view explaining update and deleting of an input image by the highlight mode of FIG. 3.

### PREFERRED EMBODIMENTS OF THE INVENTION

### First Embodiment

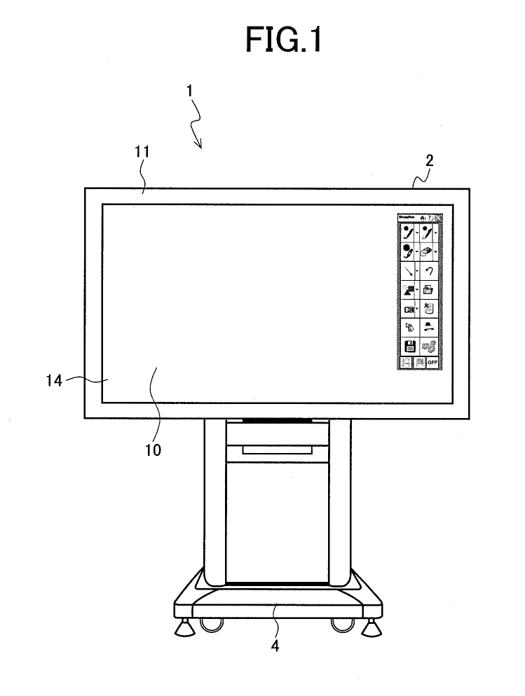

Description will hereinafter be given for an information display apparatus of the present invention with reference to drawings. FIG. 1 is a front view of the information display apparatus according to the present invention. An information display apparatus 1 has a touch panel 2 that is used for an electronic meeting system. The touch panel 2 has a touch sensor described below and, for example, a liquid crystal display, and is provided with a rectangular LCD (Liquid Crystal Display) panel having a liquid crystal layer, a glass board and the like, a protection glass, further, a direct type backlight in which, for example, LEDs are arranged in a plan manner, and the like. Note that, the display may be electronic paper, and the backlight may be composed of an edge light type.

A periphery of a front face and an outer peripheral surface of the touch panel 2 are pressed by a frame-shaped front cabinet 11, and a back face of the touch panel 2 is covered with a box-shaped back cabinet (not shown). The touch panel 2 is configured, for example, so as to be able to be installed on the floor of a room or the like with a floor stand 4.

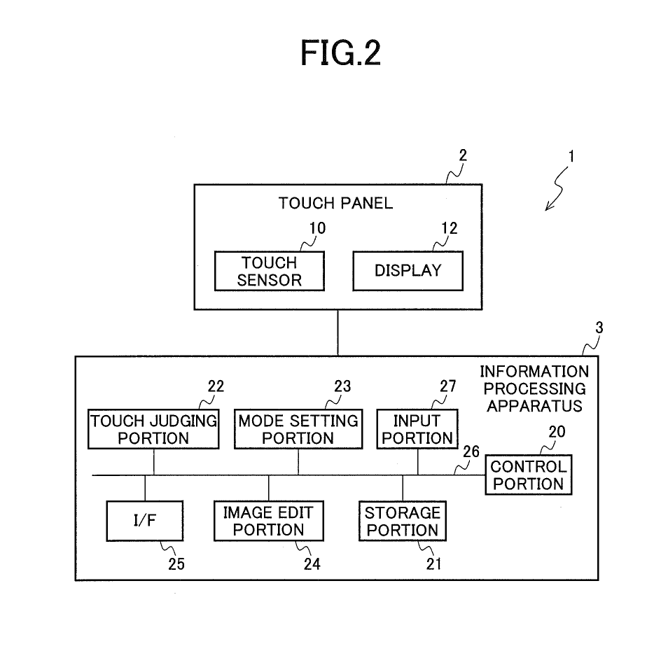

FIG. 2 is a block diagram showing a structure of the information display apparatus according to the present invention. The information display apparatus 1 is composed of the touch panel 2 and an information processing apparatus 3. The touch panel 2 is composed of, for example, a touch sensor 10 of a transparent resistance film type and a liquid crystal display 12 described above, and is formed by having the touch sensor 10 provided on the display 12. The touch sensor 10 is a sensor that detects a touch of a finger, a stylus or the like. A detection method may be constructed by an infrared camera method, an infrared blocking detection method, an electrostatic capacity method, an electromagnetic induction method or the like.

Based on an instruction from the information processing apparatus 3, for example, a material image or the like is displayed on the display 12. In the display 12, an orthogonal coordinate system for display is set, and pixels are arranged in a matrix shape along this coordinate system. A position of a pixel is output to the information processing apparatus 3, and, for example, stored in a storage portion 21.

On the other hand, the touch sensor 10 has a transparent electrode, and an orthogonal coordinate system for input is set to the transparent electrode. This orthogonal coordinate system corresponds to the orthogonal coordinate system for display.

The information processing apparatus 3 has, in addition to the storage portion 21, a control portion 20, a touch judging portion 22, a mode setting portion 23, an image edit portion 24, an I/F 25 and the like, which are connected via a bus 26.

The control portion 20 is composed of, for example, one or a plurality of CPUs (Central Processing Units) and the like, and loads, for example, various programs and data stored in a ROM of the storage portion 21 into a RAM to execute the loaded programs in the RAM. Thereby, the entire operation of the information display apparatus 1 is controlled based on the instruction content or the like from the user.

In addition, the control portion 20 causes the display 12 to display a GUI (graphical user interface) for operating the information display apparatus 1.

The touch judging portion 22 detects, for example, a touch operation to the touch panel 2 such as single tap or flick, and a touch operation to the touch panel 2 such as in the case of inputting diagrams by handwriting or the like. The detection result is converted into the above-described orthogonal coordinate system for display and output to the image edit portion 24.

A trace of this touch operation is stored in the storage portion 21 by means of a touched position and time. Note that, this time may be all of the time during the touch operation, or only start time or end time of the touch operation.

Moreover, the touch judging portion 22 is able to judge whether or not a predetermined position of the touch panel 2 described below is touched, and the like. The judgment result is output to the mode setting portion 23.

When receiving the judgment result, the mode setting portion 23 switches a current operation mode (for example, a highlight mode) to another operation mode (for example, a normal display mode), and gives an instruction of processing in accordance with the operation mode after switching, specifically, when the highlight mode is set, drawing processing to the touched position, to the image edit portion 24. Note that, the touch judging portion described above may judge whether or not the predetermined position of the touch panel 2 is touched and the like as well as switch the operation modes.

In response to a command from the touch judging portion 22 or the mode setting portion 23, the image edit portion 24 calls up image data of material, by handwriting or the like from the storage portion 21, and according to a predetermined program stored in the ROM, synthesizes a material image and an input image by handwriting or the like on the display 12 as described below. This makes it possible to simply indicate a display part that a presenter desires to emphasize with a touch operation, and a user of the information display apparatus 1 is able to see the synthesized image on the touch panel 2.

Moreover, in addition to displaying the trace of the touch operation as the input image on the touch panel 2 as described above, the image edit portion 24 deletes this input image from the touch panel 2 automatically after a predetermined time has elapsed.

The control portion 20 is able to be connected to an external device (not shown) such as a multi-functional peripheral or a personal computer (PC) via the I/F 25. For that connection, methods of short-range wireless communication, network connection, serial connection and the like are usable. The information display apparatus 1 may have the PC.

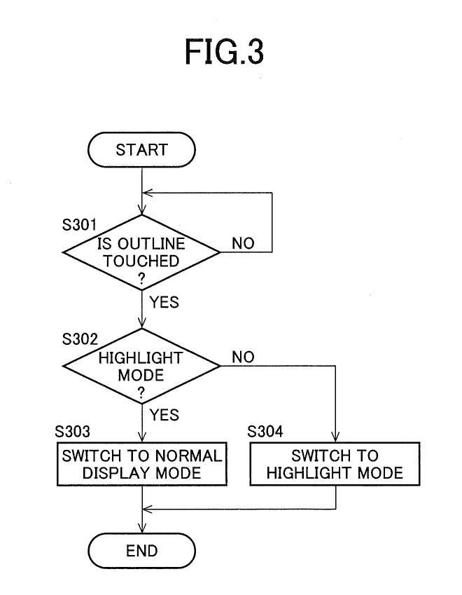

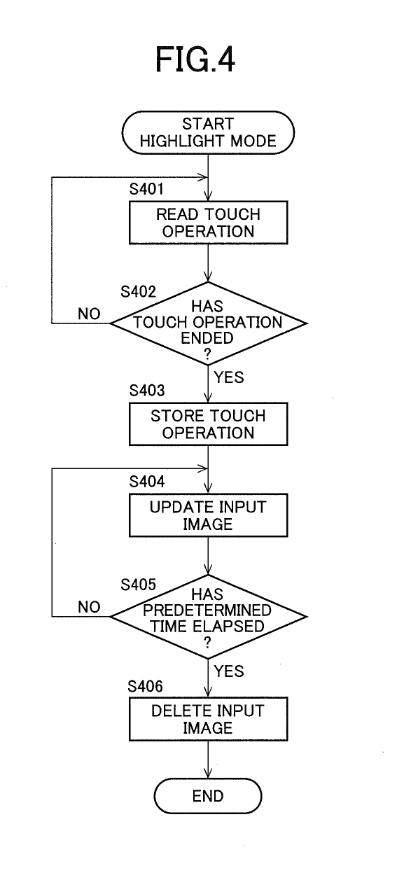

FIG. 3 is a flowchart explaining an operation in the case of switching modes according to the present invention, and FIG. 4 is a flowchart explaining an operation of the highlight mode of FIG. 3.

The touch judging portion 22 judges whether or not a user touches a predetermined position of the touch panel 2, for example, a vicinity of an outline of the touch panel 2 (step S301 of FIG. 3). For example, a mode switch area 14 shown in FIG. 1 is formed into a belt shape along an outline of the front cabinet 11.

When the user touches the mode switch area 14 (YES at step S301 of FIG. 3), the mode setting portion 23 judges whether or not an operation mode which is currently set is the highlight mode (step S302). In the case of the highlight mode (YES at step S302), the mode setting portion 23 switches to the normal display mode (step S303), and enables to receive the touch operation to the touch panel 2, for example, such as single tap or flick.

Note that, in this normal display mode, it is also possible to carry out an input operation to an external device with the touch operation to the touch panel 2.

On the other hand, when the operation mode which is currently set is the normal display mode (NO at step S302 of FIG. 3), the mode setting portion 23 switches to the highlight mode (step S304). Thereby, an input image by handwriting or the like that has been prohibited at the time of setting the normal display mode becomes possible to be input based on the touch operation to the touch panel 2.

Specifically, as shown in FIG. 4, the touch judging portion 22 reads, for example, the touch operation to the touch panel 2 by a finger of a presenter (step S401), and the image edit portion 24 synthesizes a material image on the display 12 and the trace of the touch operation detected by the touch sensor 10 to display on the touch panel 2.

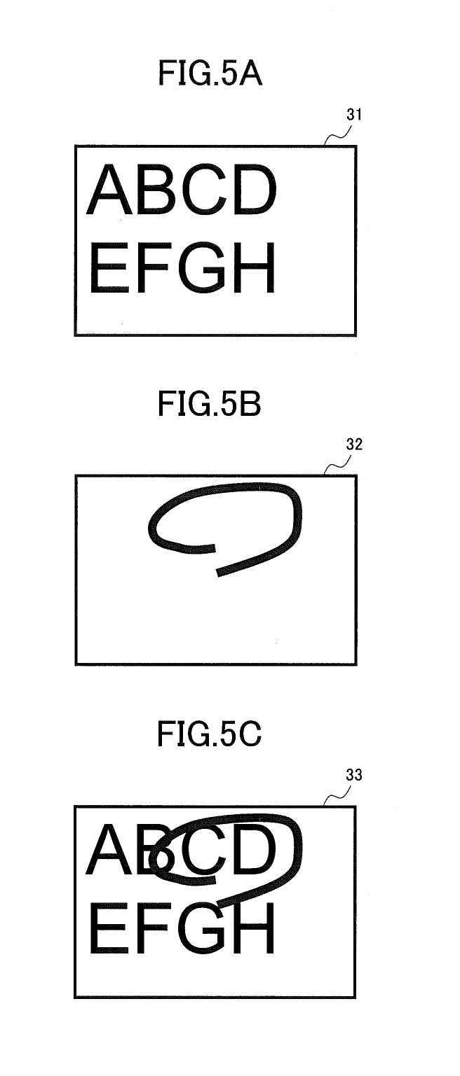

FIG. 5A through FIG. 5C are views explaining display by the highlight mode of FIG. 3. For example, assumed is a case where a material image 31 in which eight characters of alphabets A to H are written is displayed on the display 12 and a presenter desires to highlight two characters of alphabets C and D among them. In this case, the image edit portion 24 creates a trace of a touch operation of surrounding the alphabets C and D of the material image 31, for example, with a clockwise circle, as an input image 32 by handwriting or the like. Then, a synthesized image 33 that the input image 32 is superimposed on the material image 31 is created and displayed on the touch panel 2. Note that, an input image of a plurality of layers is also able to be superimposed on the material image 31.

When the finger of the presenter touches the touch panel 2, for example, draws a circle in a clockwise manner, and then separates and the touch judging portion 22 judges end of the touch operation (YES at step S402 of FIG. 4), this touch operation is stored in the storage portion 21 (step S403).

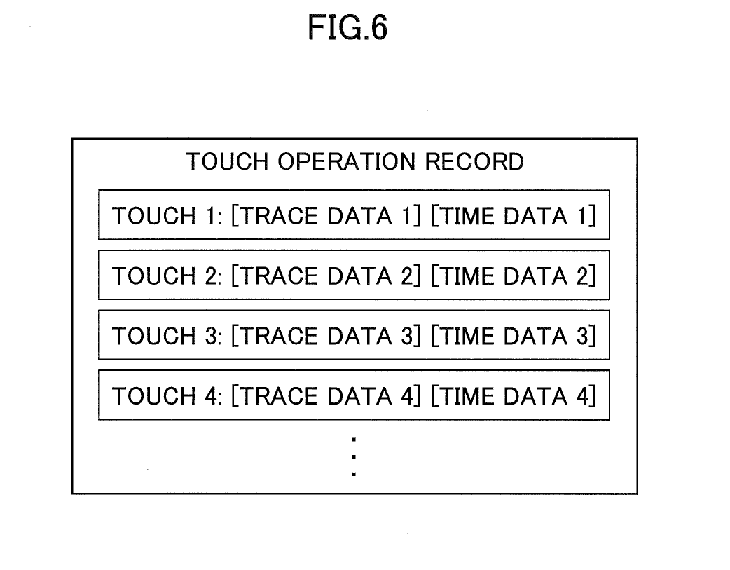

FIG. 6 is a view explaining touch operation record by the highlight mode of FIG. 3.

Trace data and time data are stored for each touch operation in the storage portion 21. In the case of the example of the input image 32 explained in FIG. 5A through FIG. 5C, the trace data is input position information from the position that is touched at first to the position that is touched lastly after moving clockwise, and the time data is input time information corresponding to each of these positions.

Note that, in FIG. 6, an example of a case where the touch operation is performed four times is shown, and trace data and time data are able to be stored for each touch operation in the storage portion 21.

Further, it is also possible to store time data of one touch operation by dividing into a plurality of sections in the storage portion 21. For example, when the user sets time data to three divisions, in addition to the input time information described above, reference time information of division is also stored for the time data.

Then, the image edit portion 24 moves to deleting of the input image based on the stored time data (steps S404 to S406 of FIG. 4). Specifically, when a predetermined time has elapsed after start of the touch operation or end of the touch operation (YES at step S405), the input image is deleted from the touch panel 2 automatically (step S406). Note that, update of the input image described in step S404 corresponds to a case where a color of the input image is changed as described below.

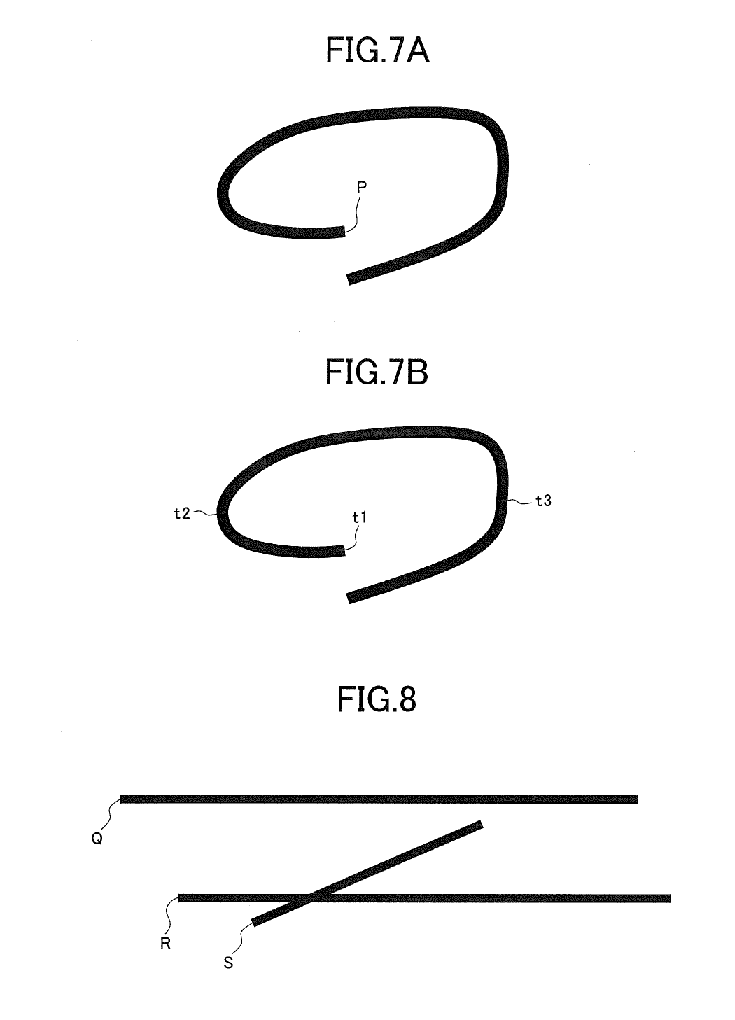

FIG. 7A and FIG. 7B are views explaining deleting of an input image by the highlight mode of FIG. 3. These figures show the input image 32 explained in FIG. 5A through FIG. 5C, while FIG. 7A shows an example that time data of this input image is not divided. Therefore, in the input image of FIG. 7A, for example, when a predetermined time (for example, ten seconds) has elapsed after time of a start point P of the touch operation, the whole of the input image disappears from the touch panel concurrently.

On the other hand, time data of the input image is divided into three of t1, t2 and t3 in FIG. 7B. Therefore, in the input image of FIG. 7B, when a predetermined time (for example, ten seconds) has elapsed after the start time t1 of the touch operation, a section corresponding to the time t1 to t2 in this input image disappears, subsequently, when a predetermined time (for example, ten seconds) has elapsed after the time t2, a section corresponding to the time t2 to t3 in this input image disappears, and thereafter, when a predetermined time (for example, ten seconds) has elapsed after the time t3, a section corresponding to the time subsequent to the time t3 in this input image disappears.

In this manner, when a predetermined time has elapsed, the input image is deleted from the touch panel 2 automatically, so that the material image before the input does not become difficult to be seen. Moreover, since concentration of the presenter does not have to be lost, a presentation using the touch panel 2 is carried out smoothly. As a result, it is possible to provide the user-friendly information display apparatus.

Further, when the input image is able to be deleted from the touch panel 2 gradually based on time data that has been divided and stored, for example, it is possible to delete the parts of the input image in the order of inputting.

### Second Embodiment

FIG. 8 is a view explaining deleting of an input image by the highlight mode of FIG. 3, and the image edit portion 24 is able to delete images in the order of inputting a plurality of touch operations, and also able to manage them as one group. Specifically, when the next touch operation starts before a predetermined time (for example, two seconds) has elapsed after end of the last touch operation, the image edit portion 24 recognizes these touch operations as a group. Thereby, though the input image of the example of FIG. 8 is composed of three different straight lines with starting points of the touch operations of Q, R and S, the image edit portion 24 is also able to delete these three input images concurrently, for example, when a predetermined time (for example, ten seconds) has elapsed after end time of the touch operation concerning the starting point S.

Note that, as described above, when the mode switch area 14 is touched, the highlight mode is switched to the normal display mode, and therefore, in the case of a specific operation, for example, when the mode switch area 14 is touched, the input images may be deleted immediately from the touch panel 2.

Moreover, the above-described input image remains in the storage portion 21 even if disappearing from the touch panel 2 after the predetermined time has elapsed. Thus, the image edit portion 24 is also able to call up the input image that has been deleted from the touch panel 2 from the storage portion 21 to display on the touch panel 2 again. In this case, for example, a restore button may be provided on the touch panel 2, or a history concerning the restore button is enabled to be displayed to cause the user to select an input image that is desired to be displayed again. Thereby, for example, even in the case of an input image of a text, the entire text is able to be redisplayed promptly.

### Third Embodiment

By the way, description has been given taking an example that an input image is deleted in the above-described embodiments, however, when considering that a material image is not made difficult to be seen, the image edit portion 24 may display an input image on the touch panel by changing to a color lighter than a color used for display content of the touch panel.

Specifically, the image edit portion 24 firstly detects a color of the input image displayed on the touch panel 2, for example, with an RGB value, and changes to a lighter color by comparing to a color of the material image stored in the storage portion 21. Further, the image edit portion 24 is also able to change the color of the input image to a lighter color by comparing to a color of the last input image.

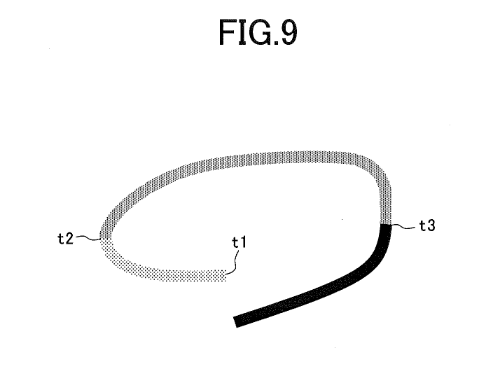

FIG. 9 is a view explaining update and deleting of an input image by the highlight mode of FIG. 3, and to explain an example of an input image in which time data is divided into three of t1, t2 and t3, when a predetermined time (for example, five seconds) has elapsed after the start time t1 of the touch operation, the image edit portion 24 changes a color of a section corresponding to the time t1 to t2 in this input image to a light color. Subsequently, when a predetermined time (for example, five seconds) has elapsed after the time t2, as shown in FIG. 9, a section corresponding to the time t1 to t2 is changed to have a much lighter color, and a section corresponding to the time t2 to t3 in the input image is changed to have a light color.

Next, when a predetermined time (for example, five seconds) has elapsed after the time t3, a section corresponding to the time t1 to t2 disappears and a section corresponding to the time t2 to t3 is changed to have a much lighter color and a section corresponding to the time subsequent to the time t3 in the input image is changed to have alight color. Then, after the section corresponding to the time t2 to t3 disappears, the section corresponding to the time subsequent to the time t3 may disappear, and it is possible to change the color from a previously input part in turn. Note that, changing of the color according to the present invention refers to changing at least any one of a transparency, a color hue, saturation and lightness.

Further, when the touch operation is performed a plurality of times, the image edit portion 24 may delete the input image corresponding to each touch operation after changing to a color lighter than a color used for display content of the touch panel for displaying based on the time data for each of the stored touch operations.

Note that, description has been given taking an example that a material image and an input image are synthesized to be displayed on the touch panel in the above-described embodiment, however, it is also possible to input the input image directly to the material image.

Hereinabove, according to the present invention, when a predetermined time has elapsed, an input image is deleted from the touch panel automatically, so that display content before the input does not become difficult to be seen. Moreover, since concentration of a presenter does not have to be lost, a presentation using the touch panel is carried out smoothly. As a result, it is possible to provide the user-friendly information display apparatus.

1. An information display apparatus capable of editing display content based on a touch to a touch panel, comprising:
a touch judging portion for judging whether or not the touch panel is touched, and
an image edit portion for displaying a trace of the touch to the touch panel that is judged by the touch judging portion on the touch panel as an input image, wherein
the image edit portion deletes the input image from the touch panel automatically after a predetermined time has elapsed.

2. The information display apparatus as defined in claim 1, wherein
the image edit portion synthesizes the trace of the touch to the touch panel with respect to the display content of the touch panel to display on the touch panel as the input image.

3. The information display apparatus as defined in claim 1, wherein
a storage portion for storing, when a touch operation to the touch panel is performed a plurality of times, input time information for each touch operation is further included, and the image edit portion deletes the input image corresponding to the touch operation from the touch panel based on the input time information that is stored.

4. The information display apparatus as defined in claim 1, wherein
a storage portion for dividing input time information of a touch operation to the touch panel into a plurality of sections for storage is further included, and the image edit portion deletes the input image corresponding to the touch operation from the touch panel based on the input time information that has been divided and stored.

5. The information display apparatus as defined in claim 1, wherein
when a predetermined operation is performed, the image edit portion displays the input image that has been deleted from the touch panel on the touch panel again.

6. The information display apparatus as defined in claim 1, wherein
before deleting from the touch panel automatically, the image edit portion changes a color of the input image to a color lighter than a color used for the display content of the touch panel to display on the touch panel.

7. The information display apparatus as defined in claim 1, wherein
a storage portion for dividing input time information of a touch operation to the touch panel into a plurality of sections for storage is further included, and before deleting from the touch panel automatically, the image edit portion changes a color of the input image corresponding to the touch operation to a color lighter than a color used for the input image of last time to display on the touch panel based on the input time information that has been divided and stored.
